(19) United States
(12) Patent Application Publication
(10) Pub. No.: US 2012/0055210 A1
(43) Pub. Date: Mar. 8, 2012

(54) LOCKING ASSEMBLY

(76) Inventor: Kenneth Biba, Laurence Harbor, NJ (US)

(21) Appl. No.: 12/877,234

(22) Filed: Sep. 8, 2010

(51) Int. Cl. E05B 67/18; E05B 67/06; E05B 67/00

(52) U.S. Cl. 70/45; 70/31; 70/49

(57) ABSTRACT

What is disclosed is a lock assembly for use with locking stainless steel or steel cables, shackle bars and/or chains. The locking mechanism is a rotating cam that can secure the cable, shackle bar or chain into the lock assembly and release the same by again rotating the cam.

### BACKGROUND OF THE INVENTION

The present invention is directed to the field of portable locking devices that can be used to provide security in a variety of applications. In particular, the present invention is directed to an internal mechanism for such locks.

The present invention is directed to the type of locks used in connection with a shackle, cable or chains. The available locking mechanisms for these types of devices are complicated, generally use pins activated by a key and are expensive to manufacture and suffer from other defects as well.

The primary object of the present invention is to overcome the problems with available locks. The present invention solves the problem with available locking mechanisms by providing a simple rotating lock assembly that is reliable yet simple to manufacture and operate.

### SUMMARY OF INVENTION

A rotating locking mechanism comprising a cylindrical outer tubular body comprising a longitudinal bore with a first opening and a first side hole, a reversibly rotating cam comprising a first through slot and received in the longitudinal bore such that the rotating cam can be freely rotated therein, a keyed lock connected to the rotating cam and a lock device adapted to be received in the first side hole and the first through slot by rotating the rotating cam by rotating the keyed lock so that the first side hole and the first through slot align wherein the lock device is secured in the rotating locking mechanism when the keyed lock is rotated and thereby the rotating cam is rotated.

A lock chain rotating locking mechanism comprising a cylindrical tubular body comprising a first longitudinal bore on a first, end, a slot on a second end, and a through hole open into the longitudinal bore; a lock chain comprising a first end link, a second end link and a plurality of links between the first end link, and the second end link wherein the first end link is affixed in the slot on the second end of the cylindrical tubular body; a reversibly rotating cam adapted to be received in the first longitudinal bore comprising an open slot, and a finger; and a keyed lock connected to the rotating cam; wherein any link other than the first end link is received in the through hole and open slot and secured in the locking mechanism by the finger when the keyed lock is rotated and thereby the reversibly rotating cam is rotated.

### BRIEF DESCRIPTION OF THE DRAWINGS

FIG. 1 is a top assembled view of an embodiment of the present invention.

FIG. 2a is a top view of a component of the embodiment illustrated in FIG. 1.

FIG. 2b is a side view of the component illustrated in FIG. 2a.

FIGS. 3a, 3b, 3c, & 3d illustrate a component of the embodiment'illustrated in FIG. 1.

FIG. 4 illustrates a cable used in conjunction with the embodiment shown in FIG. 1.

FIG. 5 is a top assembly view of a second embodiment of the present invention.

FIG. 6a is a top view of a component of the embodiment illustrated in FIG. 5.

FIG. 6b is a side view of the component illustrated in FIG. 6a.

FIGS. 7a, 7b and 7c illustrate a component of the embodiment illustrated in FIG. 5.

FIG. 8 is an assembly view of the embodiment illustrated in FIG. 5.

FIG. 9 illustrates a shackle used in connection with the embodiment illustrated in FIG. 5.

FIG. 10 illustrates a chain used in connection with the embodiment illustrated in FIG. 5.

FIG. 11 illustrates a double lock cable used in connection with the embodiment illustrated in FIG. 5.

FIGS. 12a, 12b, 12c & 12d illustrate an alternate embodiment of the present invention.

FIGS. 13a, 13b, 13c & 13d illustrate a component of the embodiment illustrated in FIG. 12.

FIGS. 14a, 14b, & 14c illustrates a component of the embodiment illustrated in FIG. 12.

FIG. 15 illustrates a chain assembly used in connection with the embodiment illustrated in FIG. 12.

### DETAILED DESCRIPTION OF THE INVENTION

The presently preferred embodiments of the present invention will now be described as illustrated in the drawings. This description should not be construed as limiting the scope of the appended claims.

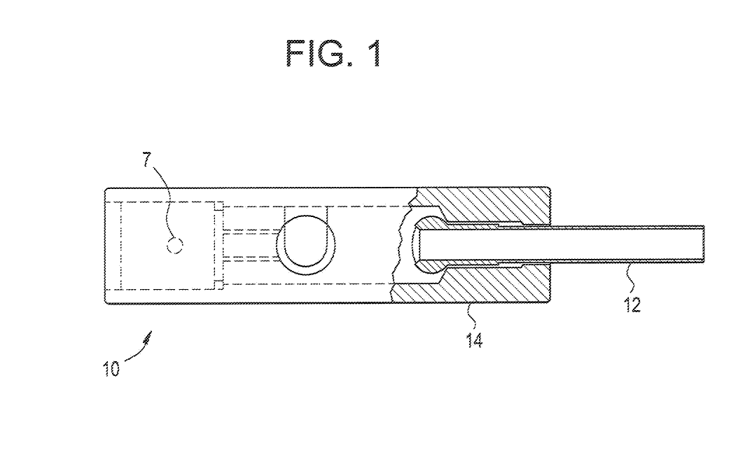

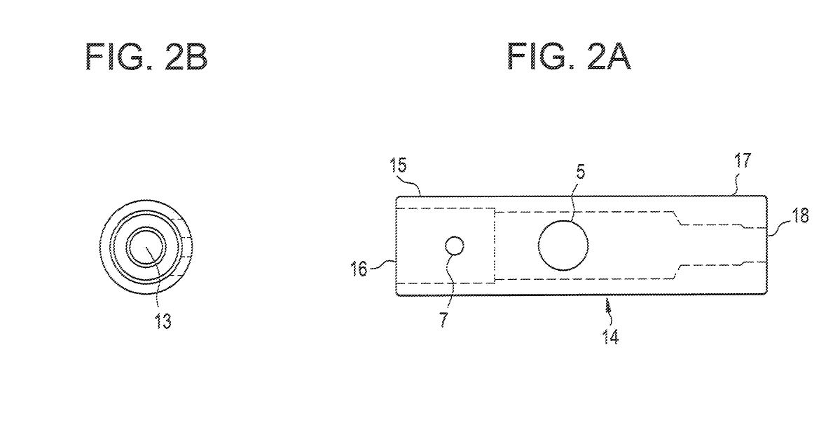

The present invention is directed to a rotating lock assembly 10 for a portable lock. The lock assembly 10 of the present invention is illustrated in FIGS. 1 through 4. This embodiment is directed to use with a lock cable assembly 12. The assembly 10 comprises a generally cylindrical outer tubular body 14. The tubular body 14 comprises a longitudinal bore 13 with a first end 15, a second end 17, a first opening 16 and a second opening 18, and a pin hole 7 as shown in FIG. 2A. The tubular body 14 further comprises a hole 5 through one side only.

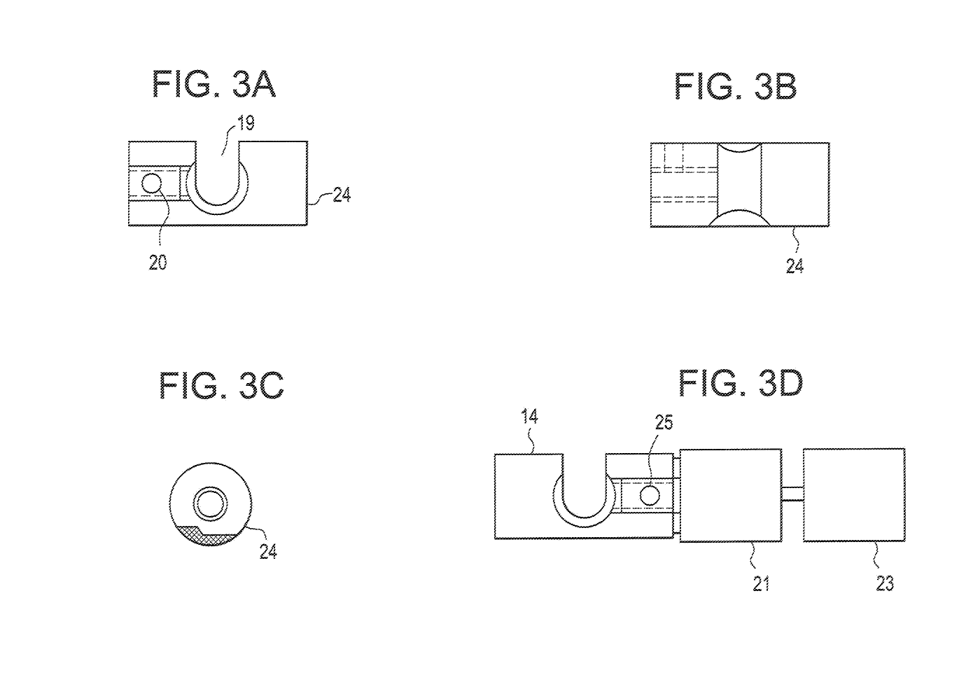

A rotating cam 24 is received in the first end 15. The cam 24 is illustrated in detail in FIG. 3. The cam 24 is generally cylindrical in shape and comprises a through slot 19. The rotating cam 24 is received in the first opening 16 and can be freely rotated in the tubular body 14. The cam 24 further comprises a pin hole 20. As can be seen in the drawings, the cam 24 is threaded into the lock mechanism 21 and is held thereon by a locking pin 25.

The lock mechanism 21 is affixed within the tubular body 14 by a pin. The lock mechanism 21 is a presently available rotating lock mechanism. The lock mechanism 21 is engaged with a key 23 on the end opposite to the rotating cam 24.

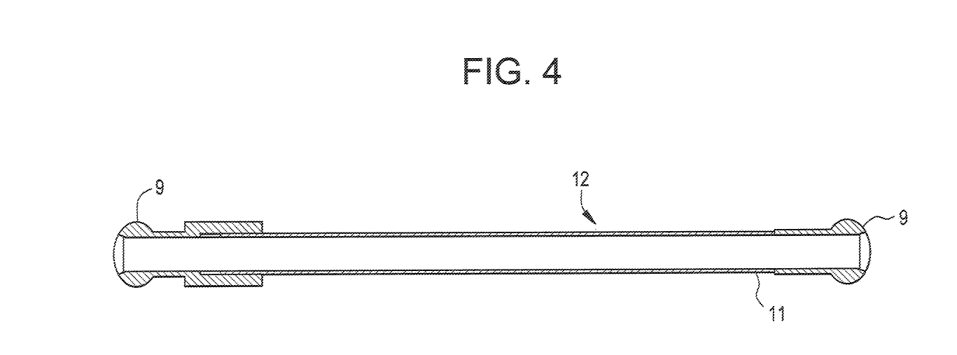

The embodiment illustrated in FIGS. 1 to 4 is meant to be used in connection with the lock cable assembly 12 illustrated in FIG. 4. The lock cable assembly 12 comprises a flexible stainless steel or steel cable 11 and a body head 9 on each end. The body head 9 is generally hollow and the cable 11 is received therein as shown in FIG. 4. Each end of the cable 11 is joined to a body head 9 by welding or swedging.

As shown in FIG. 1, one end of the cable 11 is received in the second opening 18. One of the body heads 9 is inserted through the first opening 16 and welded or swedged to the cable 11 so that the cable 11 is permanently affixed to the lock assembly 10. The flexible stainless steel or steel cable 11 may then be manipulated so that the other body head 9 is received through side hole 5 in the lock assembly 10. The cam 24 is then rotated by means of the key 23 to the open position so that the body head 9 will be received through the slot 19. After insertion, the cam 24 is rotated 180° by means of the key 23 and the lock cable assembly 12 is thereby locked therein. By rotating the cam 180° again, the lock cable assembly 12 will be released from the cam 24.

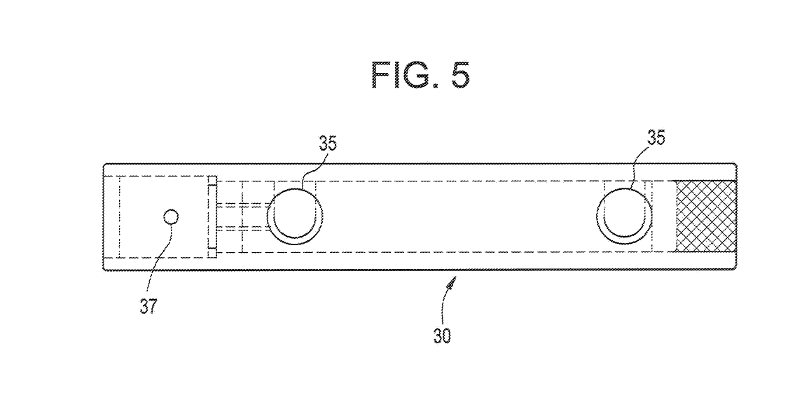

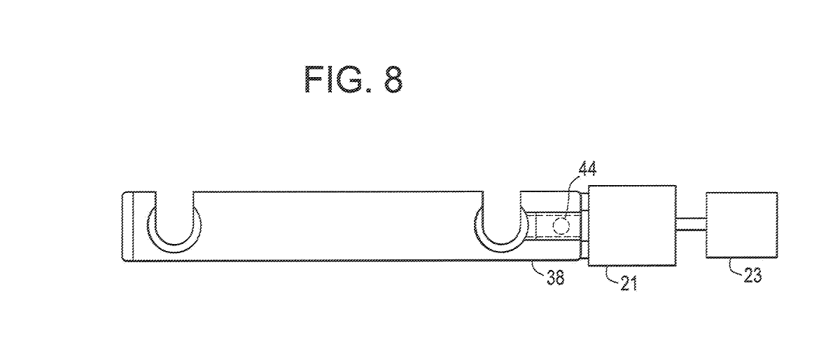

An alternate embodiment of the invention is illustrated in FIGS. 5 to 11. In this embodiment, the lock assembly 30 is to be used in connection with a stainless steel or steel cable 48 or other u-shaped shackle type device 45 or a chain 46. Rather, than the cable 48 being permanently affixed to one end of the lock assembly 30 as in the lock assembly 30, both ends may be removeably locked in place in the lock assembly 30.

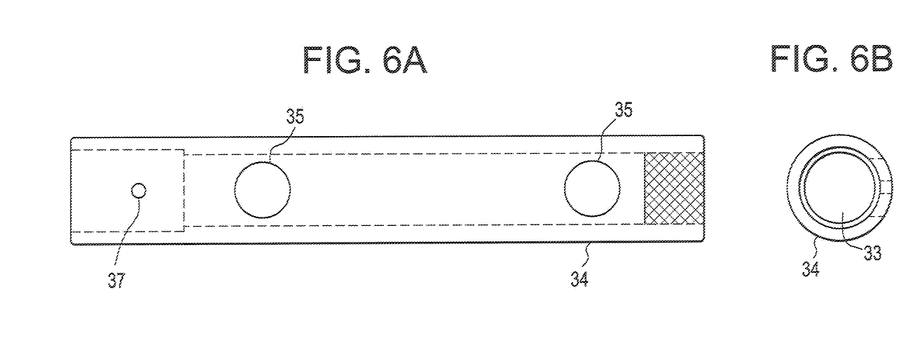

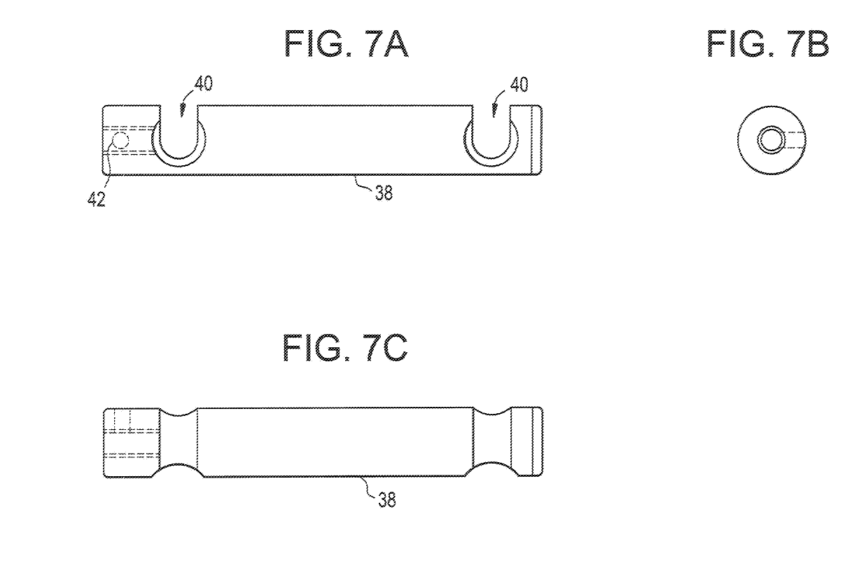

The lock assembly 30 comprises a generally cylindrical tubular outer body 34. The tubular outer body 34 comprises a longitudinal bore 33, two holes 35 and 36, and a pin hole 37 as shown in FIG. 6. The lock assembly 30 further comprises a rotating cam 38 as shown in FIG. 7. The cam 38 comprises two-through slots 40 and a pin hole 42. As with the previous embodiment, an available lock mechanism 21 is connected to the cam 38 by means of a pin 44.

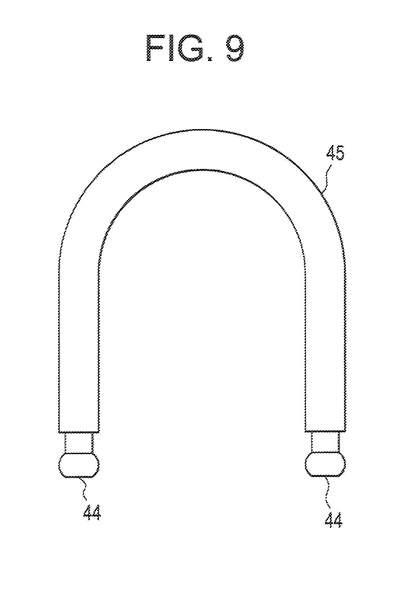

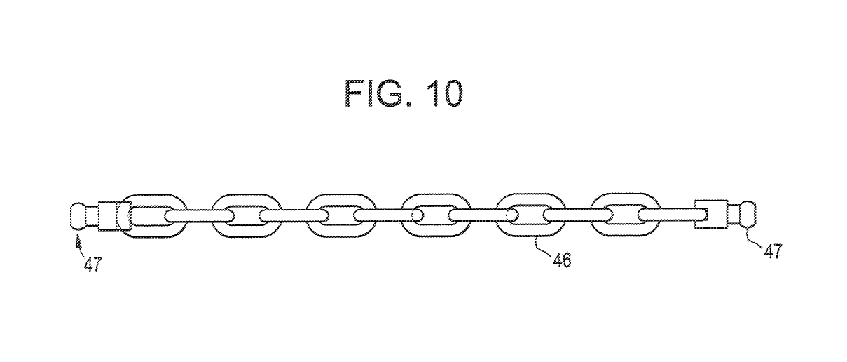

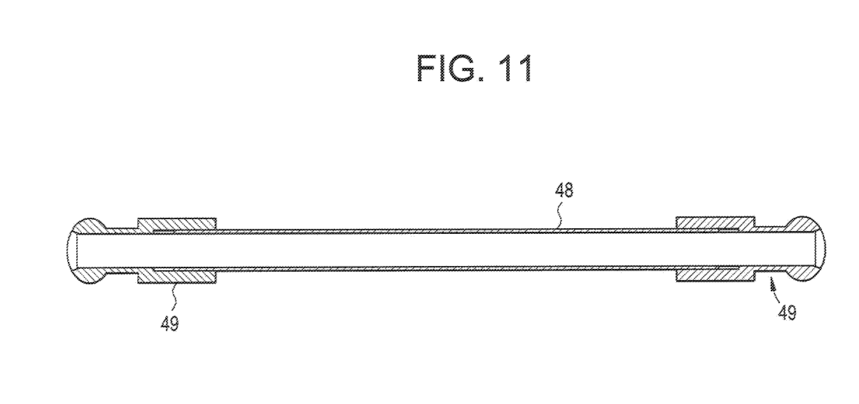

The lock assembly 30 can be used with several locking means, i.e. a shackle bar 45 shown in FIG. 9, a lock chain assembly 46 shown in FIG. 10 or a flexible stainless steel or steel cable assembly 48. As shown in FIG. 11, the lock chain assembly 46 comprises end pieces 47. The steel cable assembly 48 comprises body heads 49. In this embodiment, all of the locking means, 45, 46 and 48, are adapted so that the ends 44, 47 and 49 are received in the two side holes 35 and 36 into the rotating cam 38. The rotating cam 38 is rotated 180° by the key in the lock mechanism and the locking means is locked herein. By again rotating the cam 38 by 180°, the locking means is released from the assembly 30.

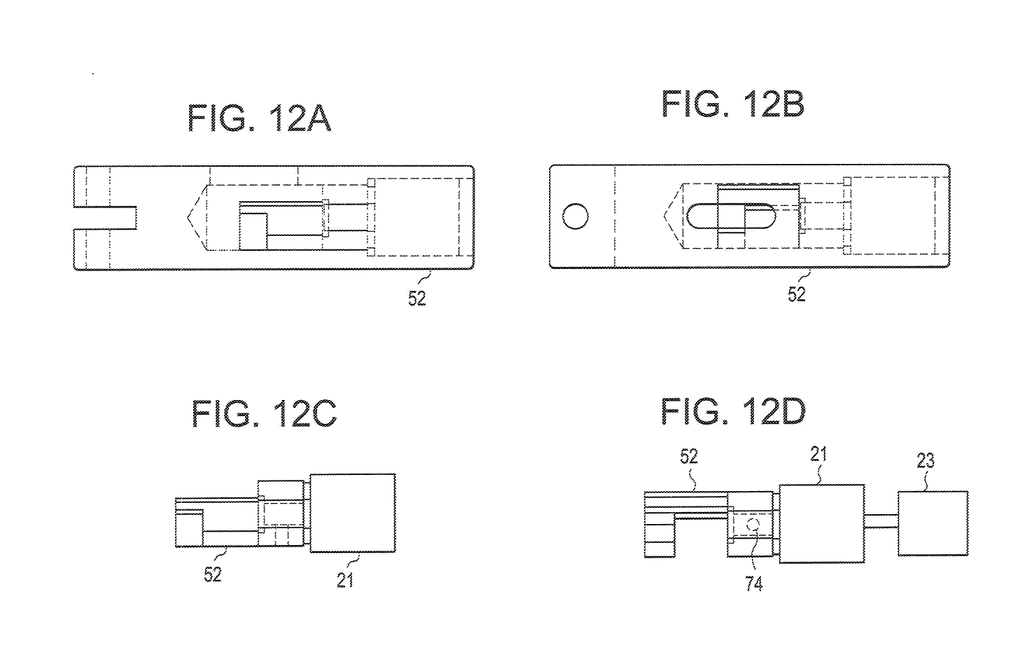

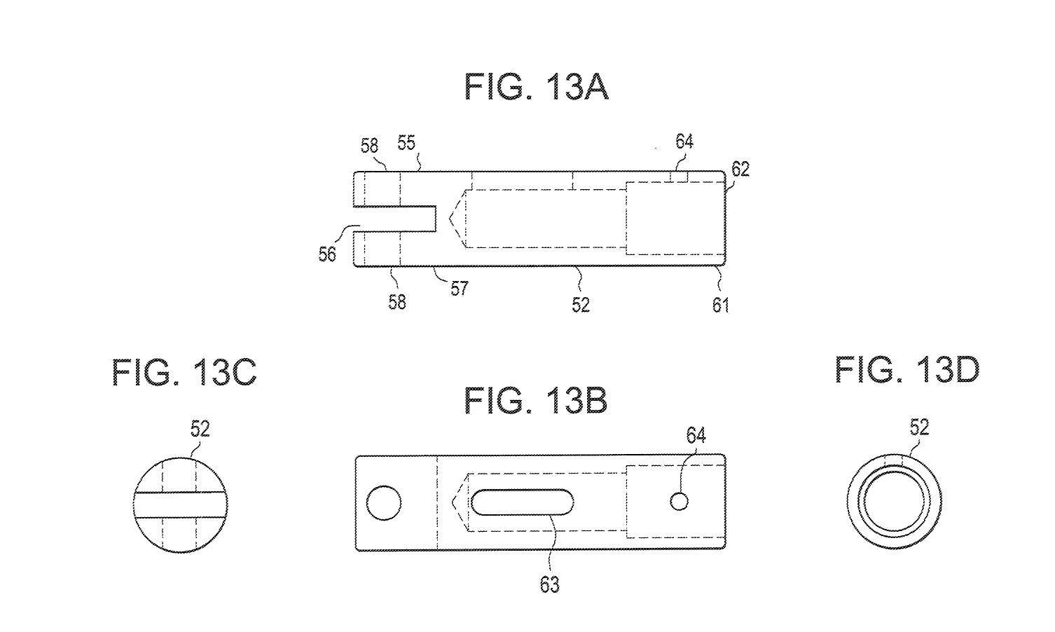

A second alternate embodiment is illustrated in FIGS. 12 to 15. In this embodiment, the lock assembly 50 is to be used in connection with a lock chain 52. The lock assembly 50 comprises a generally cylindrical tubular outer body 52.

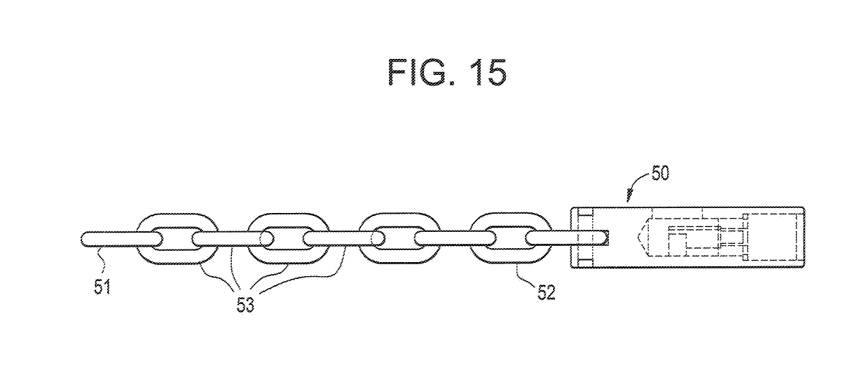

The tubular outer body 52 comprises a rectangular slot 56 with a through hole 58 on the upper and lower prongs 55 and 57 of the rectangular slot 56. The rectangular slot 56 is adapted to receive an end of the lock chain 52 therein. The lock chain 52 is fixed in the slot 56 by means of a pin 60 placed in the through hole 58 as shown in FIG. 15.

The tubular outer body 52 further comprises a longitudinal bore 62 that is open at an end 61 of the tubular outer body 52. A slot 63 is provided from the outer surface of the tubular outer body 52 into the longitudinal bore 62. The tubular outer body 52 also comprises a pin hole 64.

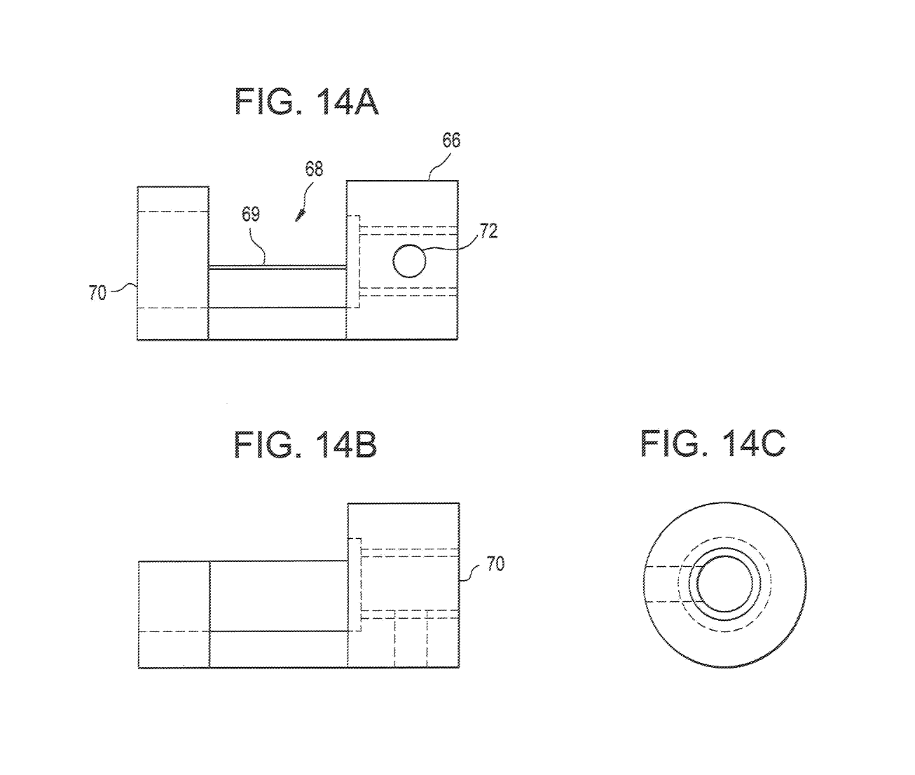

The lock assembly 50 further comprises a rotating cam 66 as illustrated in FIG. 14. The rotating cam 66 comprises an open slot 68, a finger 69, a longitudinal bore 70, and a pinhole 72. The open slot 68 is adapted to receive the end 51 or any of the plurality of links 53 of the lock chain 52. A lock mechanism 21 is connected to the cam 66 by means of a pin 74 as shown in FIG. 12d.

The lock chain 52 is received through slot 63 in the tubular outer body 52 and into the open slot 68. The cam 66 is then rotated 180° and the lock chain 52 is thus secured in the lock assembly 50 by finger 69. By rotating the cam 180° again, the lock chain 52 is released from the lock assembly 50.

Those of ordinary skill in the art will recognize that the foregoing merely represents embodiments of the present invention and that many obvious modifications may be made thereto without departing from the spirit or scope of the present invention as set forth in the appended claims.

What is claimed is:

1) A rotating locking mechanism comprising:
a) a cylindrical outer tubular body comprising a longitudinal bore with a first opening and a first side hole;
a reversibly rotating cam comprising a first through slot and received in the longitudinal bore such that the rotating cam can be freely rotated therein;
c) a keyed lock connected to the rotating cam; and
d) a lock device adapted to be received in the first side hole and the first through slot by rotating the rotating cam by rotating the keyed lock so that the first side hole and the first through slot align;
wherein the lock device is secured in the rotating locking mechanism when the keyed lock is rotated and thereby the reversibly rotating cam is rotated.

2) The rotating locking mechanism of claim 1 wherein the lock device is a lock cable assembly with a first end and a second end wherein the first end is permanently affixed to the rotating locking mechanism and the second end is received in the first side hole and the first through slot.

3) The rotating locking mechanism of claim 1 wherein the outer tubular body further comprises a second side hole, the rotating cam further comprises a second through slot and the lock device further comprises a first end adapted to be received in the first side hole and the first through slot and the second end is adapted to be received in the second side hole and the second through slot.

4. The rotating locking mechanism of claim 3 wherein the lock device is a U-shaped shackle device.

5. The rotating locking mechanism of claim 3 wherein the lock device is a lock chain wherein the first end comprises a first body head disposed thereon and the second end comprises a second body head disposed thereon.

6) A lock chain rotating locking mechanism comprising:
a) a cylindrical tubular body comprising a first longitudinal bore on a first end, a slot on a second end, and a through hole open into the longitudinal bore;
b) a lock chain comprising a first end link, a second end link and a plurality of links between the first end link and the second end link wherein the first end link is affixed in the slot on the second end of the cylindrical tubular body;
c) a reversibly rotating cam adapted to be received in the first longitudinal bore comprising an open slot, and a finger; and
d) a keyed lock connected to the rotating cam;
wherein any link other than the first end link is received in the through hole and open slot and secured in the locking mechanism by the finger when the keyed lock is rotated and thereby the reversibly rotating cam is rotated.
